(19) United States
(12) Patent Application Publication
(10) Pub. No.: US 2025/0077854 A1
(43) Pub. Date: Mar. 6, 2025

(54) DIGITAL-ANALOG MEMORY INTEGRATED DEEP LEARNING ACCELERATOR SYSTEM AND ARTIFICIAL NEURAL NETWORK LEARNING METHOD USING THE SAME

(71) Applicant: POSTECH RESEARCH AND BUSINESS DEVELOPMENT FOUNDATION, Pohang-si (KR)

(72) Inventors: Seyoung KIM, Pohang-si (KR); Doyoon KIM, Goyang-si (KR)

(73) Assignee: POSTECH RESEARCH AND BUSINESS DEVELOPMENT FOUNDATION, Pohang-si (KR)

(21) Appl. No.: 18/652,689

(22) Filed: May 1, 2024

(30) Foreign Application Priority Data
Aug. 29, 2023 (KR) 10-2023-0113702

(51) Int. Cl. G06N 3/065; G06N 3/08

(52) U.S. Cl. CPC G06N 3/065; G06N 3/08

(57) ABSTRACT

A digital-analog memory integrated deep learning accelerator system may include: a main digital device including a first array, the first array having digital circuits and configured to store weights for on-chip learning; an analog device including a second array, the second array having analog circuits and configured to update and store gradient information about the weights during the on-chip learning; and a sub-digital device including a third array, the third array having digital circuits and configured to store values read from the second array and to transfer a value exceeding a threshold to the first array. The digital-analog memory integrated deep learning accelerator system may perform a matrix-level learning process through an array set including the first array, the second array, and the third array. An artificial neural network learning method for a digital-analog memory integrated deep learning accelerator system is also disclosed.

### TECHNICAL FIELD

The present disclosure relates to artificial neural network implementation technology, and more specifically, to a method of implementing an artificial neural network which rapidly accelerates the neural network by mixing arrays implemented in analog and digital methods to enable learning on digital devices with low precision while providing high computation speed and energy efficiency while.

### BACKGROUND

Recently, research on neuromorphic devices that implement neural networks in hardware is progressing in various directions. The neuromorphic devices imitate the structure of neurons and synapses that make up the brain nervous system of a living body, and may generally include the structures of the pre-neuron located before the synapse, the synapse, and the post-neuron located after the synapse. The synapse is a connection point between neurons, and may include the function of updating synaptic weights and memorizing them according to spike signals generated from both neurons.

A deep learning accelerator implemented based on an array of synaptic elements may correspond to a dedicated device for accelerating the training of a neural network. The synaptic element array can be implemented in an analog or digital manner, and can be classified into a digital accelerator or an analog accelerator depending on the implementation method of the synaptic element array. In the case of digital accelerators, since they use a sequential calculation method, they have the disadvantage that as the array grows larger, the calculation speed becomes slower and it occupies a large area. On the other hand, in the case of analog accelerators, they have the advantage that they can store multiple levels and store a large amount of information in a small area and that they are able to perform matrix operations in complete parallel.

Therefore, if a deep learning accelerator is implemented using only the strengths of each array, an accelerator system that performs faster and more efficient calculations with a lower power can be implemented.

### PRIOR ART DOCUMENT

### Patent Document

Korean Patent Application Publication No. 10-2022-0059396 (published on May 10, 2022)

### SUMMARY

In view of the above, the present disclosure provides provide a new device set capable of designing an in-memory computing device that combines digital and analog devices to implement a neuromorphic system, in which each device is placed in a location that can take advantage of its strengths based on the advantages of the digital devices and the analog devices.

A digital-analog memory integrated deep learning accelerator system, in accordance with one embodiment of the present disclosure, comprises: a main digital element implementing a first array in a digital manner that stores weights for on-chip learning; an analog element implementing a second array in an analog manner that updates and stores gradient information about the weights during the on-chip learning; and a sub-digital element implementing a third array in the digital manner that stores values read from the second array and transfers a value exceeding a threshold to the first array, wherein the digital-analog memory integrated deep learning accelerator system performs a matrix-level learning process through an array set including the first array, the second array, and the third array.

The main digital element may perform an activation operation and an error operation through a forward propagation step and an error backpropagation step based on the weights during the on-chip learning.

The analog element may update the gradient information as a result of performing a matrix-vector product.

The analog element may determine an update size for the update based on an outer product between an activation value and an error value received from the first array.

The sub-digital element may update and store values read from the second array through a matrix-vector product operation with a one-hot vector.

The sub-digital element may adjust an update size by applying a learning rate to values read from the second array.

The sub-digital element may accumulate and store values read from the second array on a row-by-row basis.

An artificial neural network learning method, in accordance with one embodiment of the present disclosure, may comprise: performing a forward propagation step and an error backpropagation step based on weights of the main digital element; updating gradient information of the analog element using an activation value and an error value of the forward propagation step and the error back-propagation step; and updating the weights of the main digital element using a value exceeding a threshold among the gradient information read from the analog element and stored in the sub-digital element.

The updating of the gradient information may include updating the gradient information by performing a matrix-vector product operation in fully parallel.

The updating of the weights may include updating a value read from the analog element through a matrix-vector product operation with a one-hot vector and then storing the updated value in the sub-digital device.

The updating of the weights may include adjusting an update size by applying a learning rate to the value read from the analog element.

The disclosed technology can have the following effects. However, since it does not mean that a specific embodiment should include all of the following effects or only the following effects, the scope of the disclosed technology should not be understood as being limited thereby.

In the digital-analog memory integrated deep learning accelerator system and the artificial neural network learning method using the same, according to one embodiment of the present disclosure, by integrating the analog resistance changeable memory element and the digital memory array in a single chip and using the advantages and disadvantages of the digital array to introduce the algorithm that can maximize the advantages of each array and assign roles, calculation accuracy and efficiency can be achieved by using a digital array with lower bit precision which increase calculation accuracy, make full use of fully parallel calculation functions, so that it is possible to implement a new accelerator that can improve the performance of artificial intelligence learning operations by maximizing the advantages of digital accelerators and the analog accelerators while offsetting their disadvantages.

### BRIEF DESCRIPTION OF THE DRAWINGS

FIG. 1A is a diagram illustrating one example embodiment of a digital element used in a digital array.

FIG. 1B is a diagram illustrating one example embodiment of an analog element used in an analog array.

FIG. 2A provides an example of diagrams illustrating a symmetric response and an asymmetric response that may occur in an analog array.

FIG. 2B is an example of a diagram illustrating low retention characteristics among non-idealities that may occur in the analog array.

FIG. 3 is a diagram illustrating the configuration of an array set according to one or more example embodiments of the present disclosure.

FIG. 4 is a diagram illustrating a deep learning accelerator system according to one or more example embodiments of the present disclosure.

FIG. 5 is a flowchart illustrating an artificial neural network learning method according to one or more example embodiments of the present disclosure.

### DETAILED DESCRIPTION

A description of the present disclosure is merely an embodiment for a structural or functional description and the scope of the present disclosure should not be construed as being limited by an embodiment described in a text. That is, since the embodiment can be variously changed and have various forms, the scope of the present disclosure should be understood to include equivalents capable of realizing the technical spirit. Further, it should be understood that since a specific embodiment should include all objects or effects or include only the effect, the scope of the present disclosure is limited by the object or effect.

Meanwhile, meanings of terms described in the present application should be understood as follows.

The terms “first,” “second,” and the like are used to differentiate a certain component from other components, but the scope of should not be construed to be limited by the terms. For example, a first component may be referred to as a second component, and similarly, the second component may be referred to as the first component.

It should be understood that, when it is described that a component is “connected to” another component, the component may be directly connected to another component or a third component may be present therebetween. In contrast, it should be understood that, when it is described that an element is “directly connected to” another element, it is understood that no element is present between the element and another element. Meanwhile, other expressions describing the relationship of the components, that is, expressions such as “between” and “directly between” or “adjacent to” and “directly adjacent to” should be similarly interpreted.

It is to be understood that the singular expression encompasses a plurality of expressions unless the context clearly dictates otherwise and it should be understood that term “include” or “have” indicates that a feature, a number, a step, an operation, a component, a part or the combination thereof described in the specification is present, but does not exclude a possibility of presence or addition of one or more other features, numbers, steps, operations, components, parts or combinations thereof, in advance.

In each step, reference numerals (e.g., a, b, c, etc.) are used for convenience of description, the reference numerals are not used to describe the order of the steps and unless otherwise stated, it may occur differently from the order specified. That is, the respective steps may be performed similarly to the specified order, performed substantially simultaneously, and performed in an opposite order.

The present disclosure can be implemented as a computer-readable code on a computer-readable recording medium and the computer-readable recording medium includes all types of recording devices for storing data that can be read by a computer system. Examples of the computer readable recording medium may include a ROM, a RAM, a CD-ROM, a magnetic tape, a floppy disk, an optical data storage device, and the like. Further, the computer readable recording media may be stored and executed as codes which may be distributed in the computer system connected through a network and read by a computer in a distribution method.

If it is not contrarily defined, all terms used herein have the same meanings as those generally understood by those skilled in the art. Terms which are defined in a generally used dictionary should be interpreted to have the same meanings as the meanings in the context of the related art, and are not interpreted as ideal meanings or excessively formal meanings unless clearly defined in the present application.

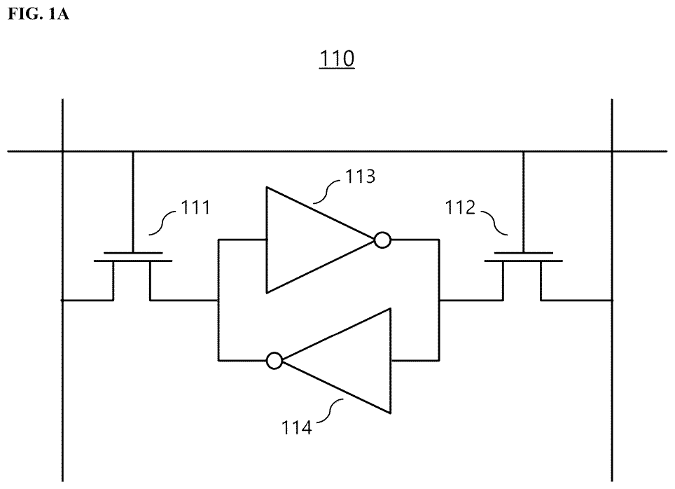

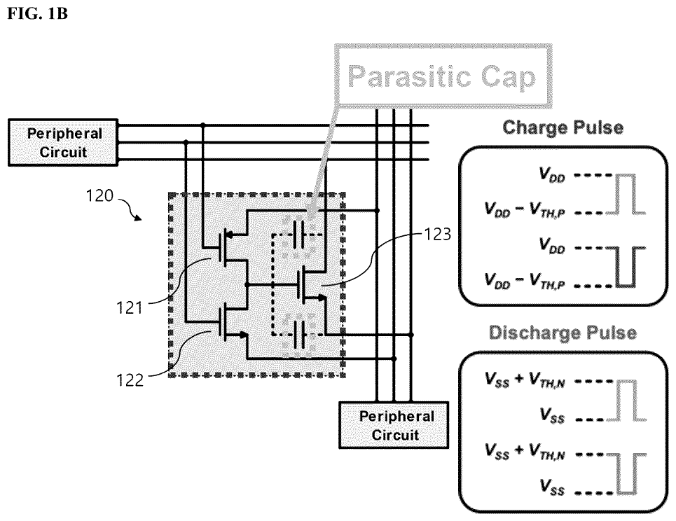

FIG. 1A is a diagram illustrating one embodiment of a digital element used in a digital array, and FIG. 1B is a diagram illustrating one embodiment of an analog element used in an analog array.

Referring to FIG. 1A, a digital array may be implemented by including a plurality of digital elements configured to store two types of information, 0 and 1. For example, a digital element 110 may include digital transistors 111 and 112 and digital inverters 113 and 114. A digital transistor may include a metal oxide semiconductor field effect transistor (MOSFET) for storing digital information. In this case, each of the plurality of digital elements may be disposed in a region where a first directional bitline (BL) and a second directional wordline (WL) intersect, resulting in an array of m×n size.

Referring to FIG. 1B, an analog array may be implemented by including a plurality of analog elements configured to store information of numerous values between minimum and maximum values. For example, the plurality of analog elements may include ReRAM (Resistive RAM), PCM (Phase Change Memory), FeRAM (Ferroelectric RAM), ECRAM (Electrochemical RAM), and the like. For example, an analog element 120 may include analog transistors 121, 122 and 123. The analog transistor 121, 122 and 123 may have parasitic capacitance. An analog transistor may include a metal oxide semiconductor field effect transistor (MOSFET) and may operate on analog signals. In this case, the plurality of analog elements can have the advantage of being able to update all values at once in parallel. However, even when the analog elements have the same conductance value, the amount of conductance updated at a time may vary depending on the direction of increase or decrease in conductance. As such, the analog elements may have disadvantages in which various non-idealities may appear.

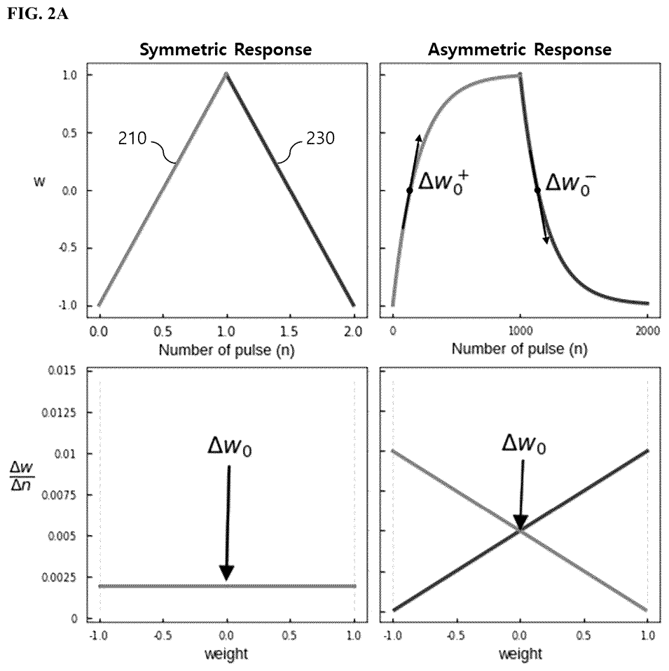

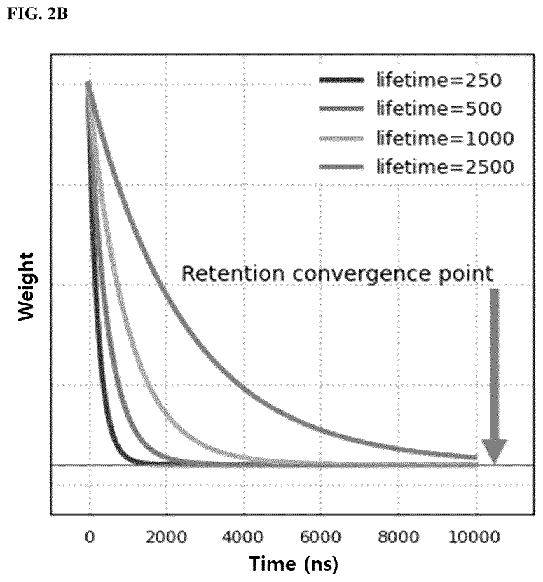

FIG. 2A provides an example of diagrams illustrating a symmetric response and an asymmetric response that may occur in an analog array. FIG. 2B is a diagram illustrating low retention characteristics among the non-idealities that may occur in an analog array.

Referring to FIG. 2A, the pulse response and weight modulation characteristic for two different devices are shown. First, the upper left and lower left figures may correspond to the pulse response of a linear and symmetrical device. Weight increase (210) and weight decrease (230) may appear to have the same gradient and may not depend on the weights. This type of device behavior can generally correspond to the ideal device required for Stochastic Gradient Descent (SGD). That is, an ideal analog element may have perfectly symmetrical update tendencies in the + and − directions, and may have very small noise, retention, and variance.

In addition, the upper right and lower right figures may correspond to the pulse response of a device which is exponentially saturated and asymmetric. That is, both weight increase and weight decrease may have a linear dependence on the weight. However, there may be a single weight value where the strengths of the weight increase and the weight decrease are the same, and that point corresponds to a symmetry point and may correspond to w=0 in the figures. That is, a typical analog element may have different update tendencies in the + and − directions, and may have non-idealities in areas such as noise, maintenance, dispersion, and number of states. Therefore, since it has non-linear characteristics, it is necessary to find a symmetry point, which is a point where the update tendencies in the + and − directions are symmetrical, and set that point as ‘0’ point before proceeding with the operation.

Referring to FIG. 2A, in the lower figures, the x-axis represents the weight, and the y-axis represents the amount of weight change.

First, in an ideal device, when a pulse is applied to all weight sections, as shown in the lower left figure, all weight changes are consistent.

However, as shown in the lower right figure, in a non-ideal device, the amount of weight to increase is stronger in the left weight section, and the amount of weight to decrease is stronger on the right. In addition, the weight whose increase and decrease amounts match between them may be referred to as a symmetry point.

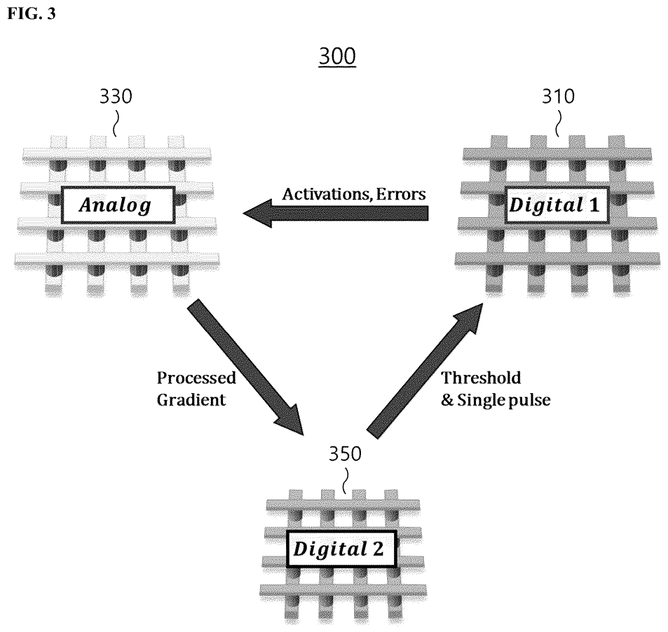

FIG. 3 is a diagram illustrating the configuration of an array set according to the present disclosure.

Referring to FIG. 3, a digital-analog memory integrated deep learning accelerator system 300 according to the present disclosure can perform a matrix-level learning process through an array set including a first array, a second array, and a third array. In this case, the first array and the third array may correspond to a synaptic element array implemented in a digital manner, and the second array may correspond to a synaptic element array implemented in an analog manner.

Specifically, the deep learning accelerator system 300 may include a main digital element 310 implementing the digital first array, an analog element 330 implementing the analog second array, and a sub-digital element 350 implementing the digital third array. In other words, the deep learning accelerator system 300 can design one array set by combining the advantages and disadvantages of an analog array with the advantages and disadvantages of a digital array and using a combination of the digital and analog arrays in appropriate locations.

The main digital element 310 may store weights for fully on-chip learning. In this case, the weight may represent the connection strength of the synaptic elements and may be adjusted by controlling the conductance by injecting electrons or holes into the charge storage layer region of the synaptic element. That is, as the learning process of the artificial neural network progresses, the weights stored in the main digital element 310 can be continuously updated.

In one embodiment, the main digital element 310 may perform an activation operation and an error operation through a forward propagation step and an error backpropagation step based on weights during on-chip learning. In other words, the forward propagation step of on-chip learning may correspond to a process in which input data of the artificial neural network propagates signals along multiple layers of the neural network to generate a final output. In the forward propagation step, the activation value may be calculated through an activation operation in the process of generating the final output. In addition, the error backpropagation step of on-chip learning may correspond to a process of calculating the error between the output generated in the forward propagation step and the target and then backpropagating it. In the error backpropagation step, the error value between the output and the target may be calculated through an error calculation. In this case, the activation value and the error value may be transmitted from the main digital element 310 to the analog element 330.

The analog element 330 may update and store gradient information regarding weights during on-chip learning. In this case, the gradient information may correspond to the error gradient of the weight value. For example, the gradient information may include a gradient of a loss function related to the weight.

In one embodiment, the analog element 330 may update gradient information as a result of performing a matrix-vector (mat-vec) product operation in fully parallel. In other words, the update process of the analog element 330 may correspond to a hardware-induced parallel update process.

In one embodiment, the analog element 330 may determine an update size for the update based on an outer product between the activation value and the error value received from the first array. For example, the update size, which determines the amount of update, may be determined by applying a preset learning rate ηₐ to the result of the outer product between the activation value and the error value.

The sub-digital element 350 may store values read from the second array of the analog element 330 and transfer values exceeding a threshold to the first array of the main digital element 310 so that the weights stored in the main digital element 310 are updated. Accordingly, the sub-digital element 350 may function as a low pass filter. In other words, the sub-digital element 350 may serve to reduce the bit precision of the main digital element 310.

Specifically, the sub-digital element 350 may accumulate and store the values read from the second array, and when a value exceeding a certain threshold (e.g., 1) is detected as a result of the accumulation, the corresponding value can be transmitted to the main digital element 310 to be initialized to 0. The value transmitted to the main digital element 310 can be updated in parallel through a single pulse.

In one embodiment, the sub-digital element 350 may update and store the value read from the second array of the analog element 330 through a matrix-vector product operation with a one-hot vector. For example, the matrix stored in the sub-digital element 350 may be multiplied by a one-hot encoded vector, and a new vector v may be generated through the product operation. Then, the vector v may be stored in the sub-digital element 350, and each vector value of the vector v may be accumulated and stored in the value stored in the sub-digital element 350.

In one embodiment, the sub-digital element 350 may adjust the update size by applying a learning rate to the value read from the second array of the analog element 330. For example, each vector value of the vector v generated through the mat-vec operation may be calculated with a preset learning rate ne and then accumulated and stored in the value stored in the sub-digital element 350, and the amount of the update may be adjusted based on the learning rate η_{c}.

In one embodiment, the sub-digital element 350 may accumulate and store values read from the second array of the analog element 330 on a row-by-row basis. That is, the values of the analog array stored in the sub-digital element 350 may be accumulated and updated on a row-by-row basis.

In one embodiment, the sub-digital element 350 may derive a moving average by averaging the accumulated values of the values received from the analog element 330, and transmit the moving average back to the analog element 330. In this case, the moving average may be calculated as in Equation 1 below and updated when moving to the main digital element 310 or the sub-digital element 350.

### (Equation 1)

$$moving average = moving average * \frac{wind o w - 1}{w i n d o w} + A * \frac{1}{wind o w}$$

Further, the moving average may be calculated by adding the existing average and the value of the new analog element 330 at a specific ratio, and the specific ratio may be defined as a window. The specific ratio may be kept constant or the degree of convergence may be adjusted by varying the corresponding values. When transmitting the average value of the analog element 330, the average value may be continuously updated and treated as an offset, and periodic attenuation may be added at each update to prevent the phenomenon of divergence in asymmetric elements.

In this case, the periodic attenuation may be applied by defining a gamma parameter between 0 and 1 and multiplying the moving average by the gamma parameter to reduce the moving average. In addition, the moving average needs to be optimized according to the characteristics of the element, and when an appropriate value is selected, a smooth curve can be drawn and the update value can quickly converge to one point.

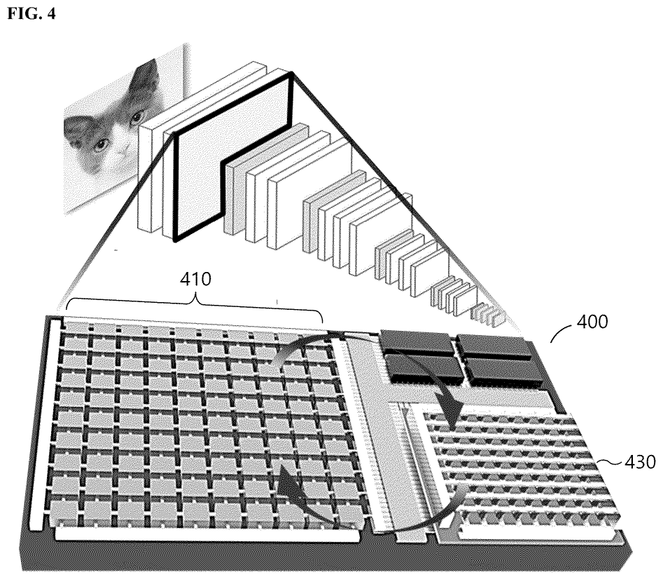

FIG. 4 is a diagram illustrating a deep learning accelerator system according to the present disclosure.

Referring to FIG. 4, the deep learning accelerator system 400 may include an array set in which the digital array 410 implemented in a digital manner and the analog array 430 implemented in an analog manner are combined to play their respective roles in the learning process, so that the array set performs learning of a single matrix. For example, the main digital element 310 and the sub-digital element 350 of FIG. 3 may be implemented on the digital array 410, and the analog element 330 may be implemented on the analog array 430.

As a result, the deep learning accelerator system 400 can design an in-memory computing device that combines digital and analog devices to implement a neuromorphic system, and can implement a new device set in which each device is disposed in a position to take advantage of its strengths based on the advantages of the digital device and the analog device.

In other words, since the main digital array implemented in the digital domain should store accurate values, it can store deterministic values in which non-ideality does not exist. On the other hand, the analog array implemented in the analog domain can perform the outer product of the gradient quickly and in parallel and store the result. In addition, the main digital array can be assisted by other sub-digital arrays implemented in the digital domain to enable calculations with low precision arrays only.

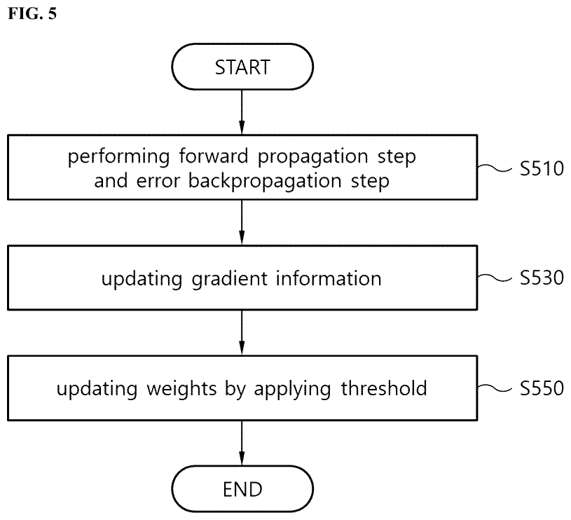

FIG. 5 is a flowchart illustrating an artificial neural network learning method according to the present disclosure.

Referring to FIG. 5, the deep learning accelerator system 300 can implement a dual memory architecture with digital and analog arrays by using only the strengths of each array. For example, by introducing the Tiki-Taka version 2 learning algorithm to an array set including two digital arrays and one analog array, the deep learning accelerator system 300 can perform fast and highly efficient calculations with low-power, and perform the artificial neural network learning method on-device.

A typical artificial neural network may include an input layer, a hidden layer, and an output layer. In this case, the unit in which several neurons are gathered is called a layer, and a fully connected layer structure may correspond to a structure in which all cases of each layer are connected. That is, when the neurons in the input layer and the neurons in the output layer are connected in the same number of cases as possible connections, it can correspond to a fully connected layer.

In addition, the input layer may receive inputs and pass them to the next layer, the hidden layer. The hidden layer is a fully connected layer connected to the input layer and may be a key layer in solving complex problems. Finally, the output layer is a fully connected layer that follows the hidden layer and may be used to transmit the output signal to the outside of the neural network, and the function of the neural network may be determined by the activation function of the output layer.

The training process of a neural network may be comprised of a forward pass and a backward pass, and the forward pass may correspond to a process in which an input value passes through the hidden layers and proceeds to the output layer. In addition, the gradient of the error value may be transmitted to each neuron through a backward pass, and then updates may be made.

Specifically, the artificial neural network learning method according to the present disclosure may perform a forward propagation step and an error backpropagation step during on-chip learning using weights stored in the main digital element 310 (Step S510). That is, the activation operation and the error operation can be performed through the forward propagation step and the error backpropagation step, and as a result, an activation value and an error value can be calculated.

Then, the gradient information according to learning may be updated and stored in the analog element 330 (Step S530). The gradient information stored in the analog element 330 may be read out by the sub-digital element 350 and then accumulated and stored. Values that exceed a certain threshold (e.g., 1) as a result of accumulation in the sub-digital element 350 may be transmitted to the main digital element 310, and the main digital element 310 may update the weights through the transmitted value (Step S550).

Meanwhile, in the structure of an algorithm (Tiki-Taka) that can compensate for non-ideality, the algorithm can use two matrices, C matrix that is the main array and A matrix that is the sub-array and represents gradient information, and can be performed by updating the gradient of the C matrix to the A matrix according to a specific learning rate, and updating some values of the A matrix to the C matrix at each specific epoch.

In the case of the Tiki-Taka version 2 learning algorithm, the above algorithm may correspond to a new algorithm that increases the tolerance for non-ideality by adding a new array (or matrix) to the Tiki-Taka version 2 learning algorithm. H matrix, a new matrix, can be implemented in the digital domain together with the C matrix, the main array, and can be updated by transferring the value of the A matrix and accumulating it in the existing value. The h matrix may have a structure such that when the accumulated value exceeds a certain threshold, it is transferred to the C matrix.

In one or more aspects, a main digital element may be referred to as a main digital device or a main digital circuit. In one or more aspects, an analog element may be referred to as an analog device or an analog circuit. In one or more aspects, a sub-digital element may be referred to as a sub-digital device or a sub-digitial circuit. In one or more aspects, a circuit may include one or more circuits. In one or more aspects, a circuit may include one or more transistors. In one or more aspects, a circuit may include one or more passive devices. In one or more aspects, a passive device may include one or more capacitors.

Although the present disclosure has been described above with reference to the preferred embodiments, it will be understood that those skilled in the art may make various modifications and changes to the present disclosure without departing from the idea and scope of the present disclosure as set forth in the following claims.

### DESCRIPTION OF REFERENCE NUMERALS

300, 400: deep learning accelerator system
310: main digital element
330: analog element
350: sub-digital element
410: digital array
430: analog array

What is claimed is:

1. A digital-analog memory integrated deep learning accelerator system, comprising:
a main digital device including a first array, the first array having digital circuits and configured to store weights for on-chip learning;
an analog device including a second array, the second array having analog circuits and configured to update and store gradient information about the weights during the on-chip learning; and
a sub-digital device including a third array, the third array having digital circuits and configured to store values read from the second array and to transfer a value exceeding a threshold to the first array,
wherein the digital-analog memory integrated deep learning accelerator system is configured to perform a matrix-level learning process through an array set including the first array, the second array, and the third array.

2. The digital-analog memory integrated deep learning accelerator system of claim 1, wherein the main digital device is configured to perform an activation operation and an error operation through a forward propagation step and an error backpropagation step based on the weights during the on-chip learning.

3. The digital-analog memory integrated deep learning accelerator system of claim 1, wherein the analog device is configured to update the gradient information as a result of performing a matrix-vector product.

4. The digital-analog memory integrated deep learning accelerator system of claim 1, wherein the analog device is configured to determine an update size for updating the gradient information based on an outer product between an activation value and an error value received from the first array.

5. The digital-analog memory integrated deep learning accelerator system of claim 1, wherein the sub-digital device is configured to update and store the values read from the second array through a matrix-vector product operation with a one-hot vector.

6. The digital-analog memory integrated deep learning accelerator system of claim 5, wherein the sub-digital device is configured to adjust an amount of updating the values by applying a learning rate to the values read from the second array.

7. The digital-analog memory integrated deep learning accelerator system of claim 5, wherein the sub-digital device is configured to accumulate and store the values read from the second array on a row-by-row basis.

8. An artificial neural network learning method for a digital-analog memory integrated deep learning accelerator system including a main digital device and a sub-digital device that include a digital array, and an analog device that includes an analog array, the method comprising:
performing a forward propagation operation and an error back-propagation operation based on weights of the main digital device;
updating gradient information of the analog device using an activation value and an error value of the forward propagation operation and the error back-propagation operation; and
updating the weights of the main digital device using a value exceeding a threshold among the gradient information read from the analog device and stored in the sub-digital device.

9. The artificial neural network learning method of claim 8, wherein the updating of the gradient information includes updating the gradient information by performing a matrix-vector product operation in fully parallel.

10. The artificial neural network learning method of claim 8, wherein the updating of the weights includes updating a value read from the analog device through a matrix-vector product operation with a one-hot vector and then storing the updated value in the sub-digital device.

11. The artificial neural network learning method of claim 10, wherein the updating of the weights includes adjusting an update size by applying a learning rate to the value read from the analog device.
